(19) United States
(12) Patent Application Publication
(10) Pub. No.: US 2026/0081659 A1
(43) Pub. Date: Mar. 19, 2026

(54) PREDICTIVE RECEIVE BEAM PRE-REFINEMENT WITH NETWORK ASSISTANCE

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/104,143

(22) PCT Filed: Nov. 4, 2022
(86) PCT No.: PCT/CN2022/129775

§ 371 Date: Feb. 14, 2025

(51) Int. Cl. H04B 7/06

(52) U.S. Cl. CPC H04B 7/0626; H04B 7/06966; H04B 7/06968

(57) ABSTRACT

Certain aspects of the present disclosure provide techniques for predictive receive beam pre-refinement with network assistance. An example method, performed by a network entity, may include predicting, prior to a first time occasion, channel characteristics for a second time occasion that occurs after the first time occasion, outputting, for transmission to a user equipment (UE) at the first time occasion, one or more channel state information reference signals (CSI-RSs) with pre-processing based on the channel characteristics predicted for the second time occasion, and outputting, for transmission to the UE, a downlink channel or reference signal at the second time occasion.

### BACKGROUND

### Field of the Disclosure

Aspects of the present disclosure relate to wireless communications, and more particularly, to techniques for predictive receive beam pre-refinement with network assistance.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a network entity. The method includes predicting, prior to a first time occasion, channel characteristics for a second time occasion that occurs after the first time occasion; outputting, for transmission to a user equipment (UE) at the first time occasion, one or more channel state information reference signals (CSI-RSs) with pre-processing based on the channel characteristics predicted for the second time occasion; and outputting, for transmission to the UE, a downlink channel or reference signal at the second time occasion.

Another aspect provides a method of wireless communication at a UE. The method includes performing measurements of one or more CSI-RSs at a first time occasion; adjusting one or more receive characteristics, based on the measurements; and processing at least one downlink channel or reference signal at a second time occasion using the adjusted one or more receive characteristics.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a diagram illustrating example operations where beam management may be performed.

FIG. 6 illustrates an example call flow diagram in accordance with aspects of the present disclosure.

FIG. 7 illustrates an example of predictive receive beam pre-refinement.

FIG. 8A and FIG. 8B illustrate an example of predictive receive beam pre-refinement.

FIG. 9A and FIG. 9B illustrate an example of predictive receive beam pre-refinement.

FIG. 10A and FIG. 10B illustrate an example of predictive receive beam pre-refinement.

FIG. 11 illustrates an example of predictive receive beam pre-refinement.

FIG. 12 depicts a method for wireless communications.

FIG. 13 depicts a method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for predictive receive beam pre-refinement with network assistance.

In wireless communications, various procedures may be performed to manage transmit and receive beams used by different entities, such as a user equipment (UE) and network entity (e.g., a base station). In one example of beam management, a network entity may transmit reference signals (e.g., channel state information reference signals (CSI-RS)) while changing (sweeping through) different transmit beams, while a UE determines which transmit beam (or set of transmit beams) resulted in the best received signal (and may provide feedback regarding the same). Similarly, to refine a receive beam at the UE, the network entity may send multiple repetitions of a reference signal using the same transmit beam (e.g., the transmit beam indicated by the feedback), while the UE sweeps through different receive beams, ultimately selecting the receive beam that resulted in the best results.

In some scenarios, such receive (Rx) beam refinement is generally causal in the time domain (TD). For example Rx beam(s) refined at a TD occasion to may be used for receiving physical downlink channels (e.g., physical downlink control channels (PDCCHs) and/or physical downlink shared channels (PDSCHs) collectively PDxCHs) at TD occasion t₁, where t₀<t₁. In other words, Rx beam refinement at an earlier TD occasion may be used for receiving PDxCHs at a later TD occasion.

Unfortunately, in other scenarios, the results of such receive beam refinement might become stale (out of date) relatively quickly. In other words, UE receive beams refined at a first time domain (TD) occasion t₀ may not be optimal for receiving a downlink transmission at a second (later) TD occasion t₁, where t₀<t₁. For example, due to fast UE rotation or human body blockage, which may occur in extended reality (XR) scenarios w/ periodic and high throughput traffic, a pre-refined Rx beam may be outdated when it is later used for actually receiving a data.

Aspects of the present disclosure, however, may provide network assistance to aid a UE in Rx pre-refinement that may achieve an Rx beam that is more suitable at a later time. For example, the network entity may predict (network to UE) channel characteristics for a later time. The network entity may pre-process (e.g., pre-equalize) downlink reference signals sent at TD occasion t₀, such that beam refinement performed based on the downlink reference signal measurements may be more suitable to be used by the UE at later TD occasion t₁. By pre-processing the downlink reference signals transmitted at TD occasion t₀ in this manner, the network entity may, in effect, mimick the channel conditions at TD occasion t₁.

Using the network-assisted beam refinement proposed herein, a beam determined based on Rx pre-refinement at an earlier time may be effective at a later time, even if channel conditions have changed. As a result, the techniques described herein may help avoid beam failures, may lead to improved performance, and improved user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

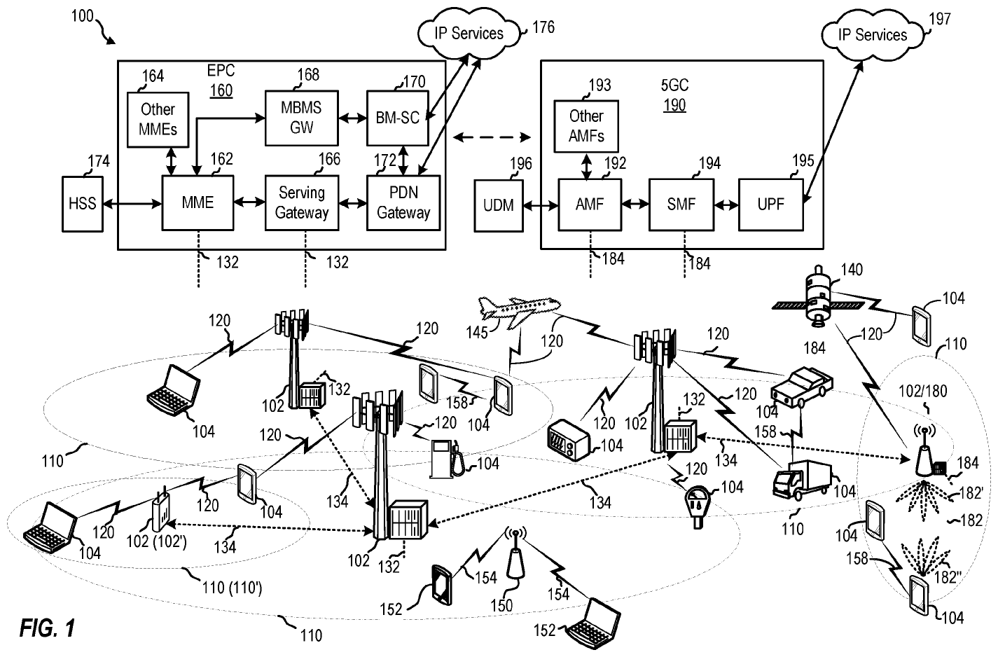

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

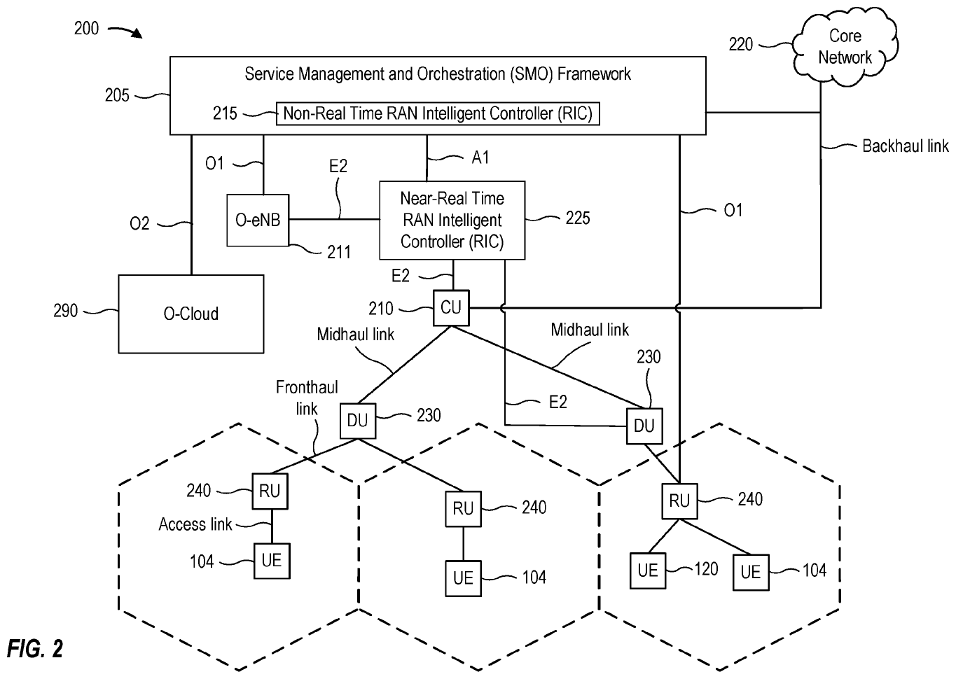

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz 7125 MHz, which is often referred to (interchangeably) as “Sub-6 GHZ”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

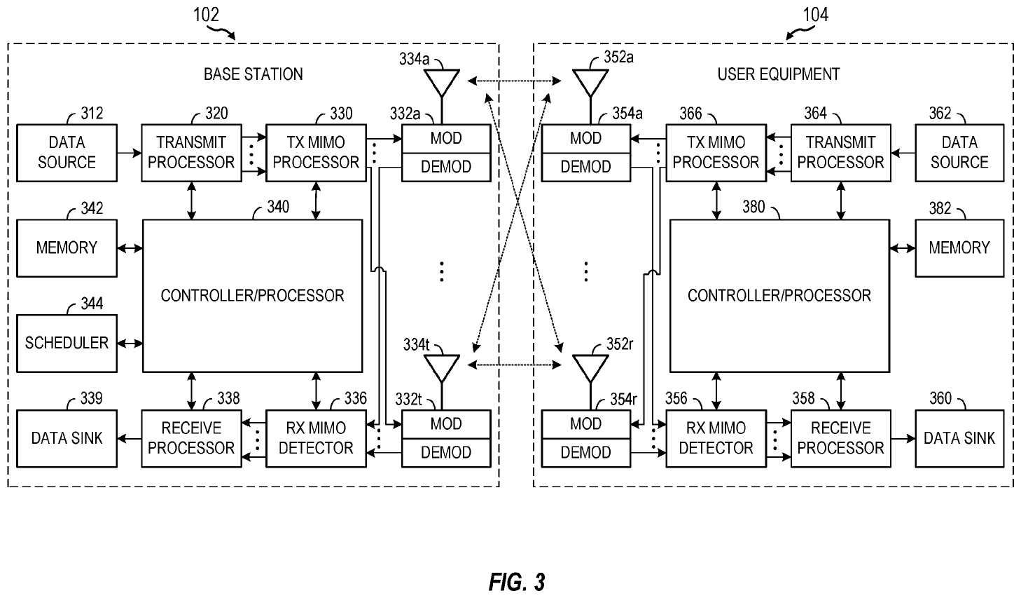

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

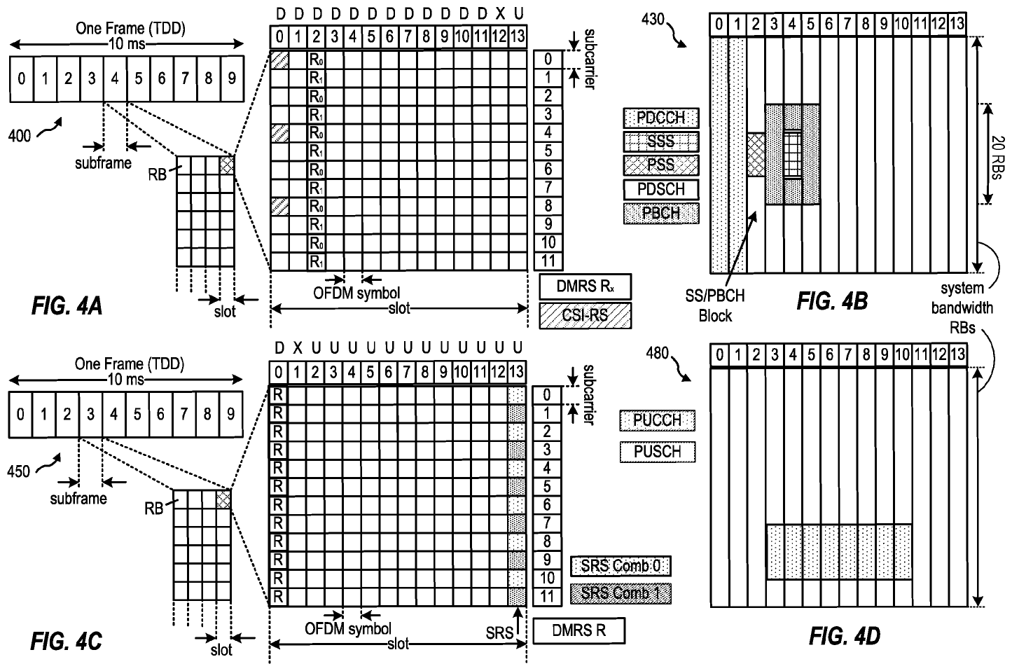

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Beam Management

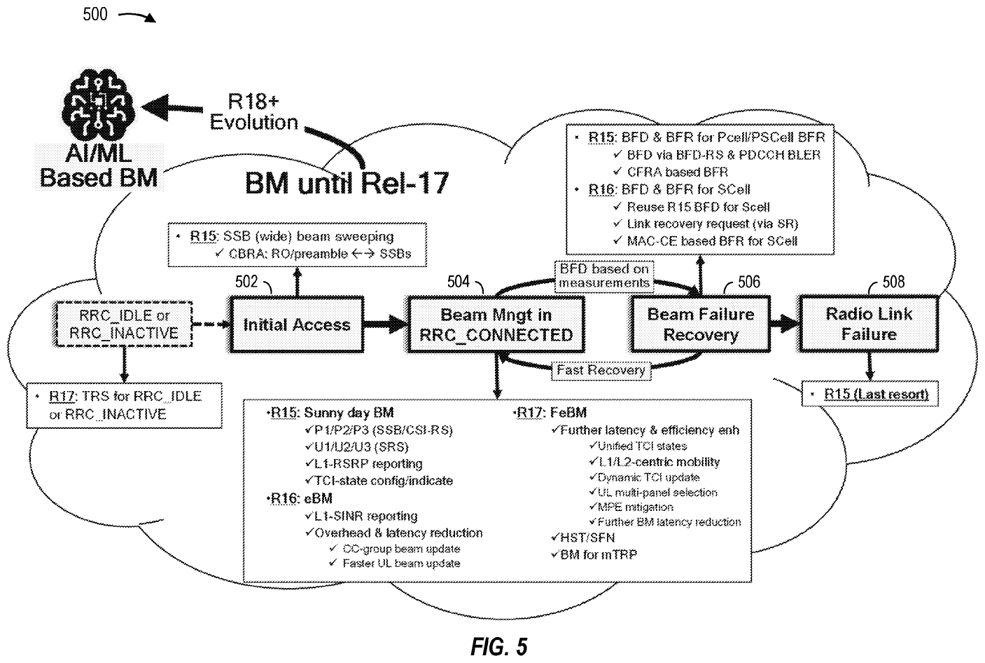

In wireless communications, various procedures may be performed for beam management. FIG. 5 is a diagram illustrating example operations where beam management may be performed. In initial access 502, the network may sweep through several beams, for example, via synchronization signal blocks (SSBs), as further described herein with respect to FIG. 4B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS). A UE may use SSB detection to identify a RACH occasion (RO) for sending a RACH preamble (e.g., as part of a contention CBRA procedure).

In connected mode 504, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 506, which may allow a UE to return to connected mode 504 without performing a radio link failure procedure 508. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 508 to recover from the radio link failure, such as a RACH procedure.

### Aspects Related to Predictive Receive Beam Pre-Refinement With Network Assistance

As noted above, in certain scenarios, the results of receive beam refinement might become out of date relatively quickly. In other words, UE receive beams refined at a first TD occasion t₀ may not be optimal for receiving a downlink transmission at a second (later) TD occasion t₁, where t₀<t₁. For example, due to fast UE rotation or human body blockage, which may occur in XR scenarios with periodic and high throughput traffic, a pre-refined Rx beam may be outdated when it is later used for actually receiving a data.

Aspects of the present disclosure, however, may provide network assistance to aid a UE in Rx pre-refinement that may achieve an Rx beam that is more suitable at a later time. For example, the network entity may predict (network to UE) channel characteristics for a later time (e.g., TD occasion t₁). The network entity may pre-process (e.g., pre-equalize) downlink reference signals sent at TD occasion t₀, such that beam refinement performed based on the downlink reference signal (DL-RS) measurements may be more suitable to be used by the UE at later TD occasion t₁. By pre-processing the downlink reference signals transmitted at TD occasion t₀ in this manner, the network entity may, in effect, mimick the channel conditions at TD occasion t₁. The UE may assume that the channel (at t₀ when receiving such DL-RS) is pre-equalized by the network entity and mimics channel characteristics predicted for t₁, and refine its Rx beam(s) according. In other words, Rx beam refinement based on predictions for a later TD occasion may be used for receiving PDxCHs at an earlier TD occasion.

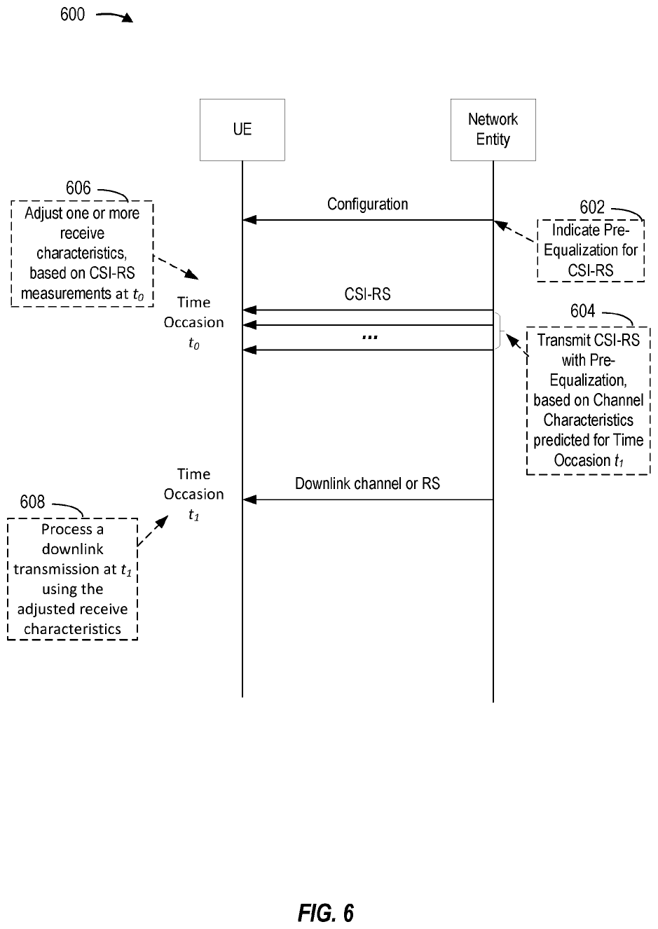

The techniques for predictive receive beam pre-refinement with network assistance proposed herein may be understood with reference to the call flow diagram 600 of FIG. 6.

In some aspects, the network entity depicted in FIG. 6 may be an example of the BS 102 depicted and described with respect to FIGS. 1 and 3 or a disaggregated base station depicted and described with respect to FIG. 2. Similarly, the UE depicted in FIG. 6 may be an example of UE 104 depicted and described with respect to FIGS. 1 and 3.

As illustrated, at 602, the network entity may transmit, to the UE, a configuration indicating the network entity will apply pre-processing (e.g., pre-equalization) for CSI-RS, transmitted at a first time occasion t₀.

The network entity may predict channel characteristics for a second time occasion (e.g., t₁) that occurs after the first time occasion, t₀. The prediction may be based on a machine learning (ML) model.

At 604, the network entity may transmit CSI-RS repetitions at the first time occasion, t₀, with pre-processing (e.g., pre-equalization) based on the channel characteristics predicted for the second time occasion, t₁. The pre-processing may be designed to effectively mimic the channel at the second time occasion, t₁, for example, such that the Rx beam refinement performed by UE will be suitable for processing a subsequent downlink transmission at the second time occasion, t₁.

The UE may measure the CSI-RS and, at 606, the UE may adjust one or more receive characteristics based on measurements of the CSI-RS at t₀. At 608, the UE may process a downlink transmission (e.g., a downlink channel or RS output for transmission by the network entity) at t₁ using the adjusted receive characteristics.

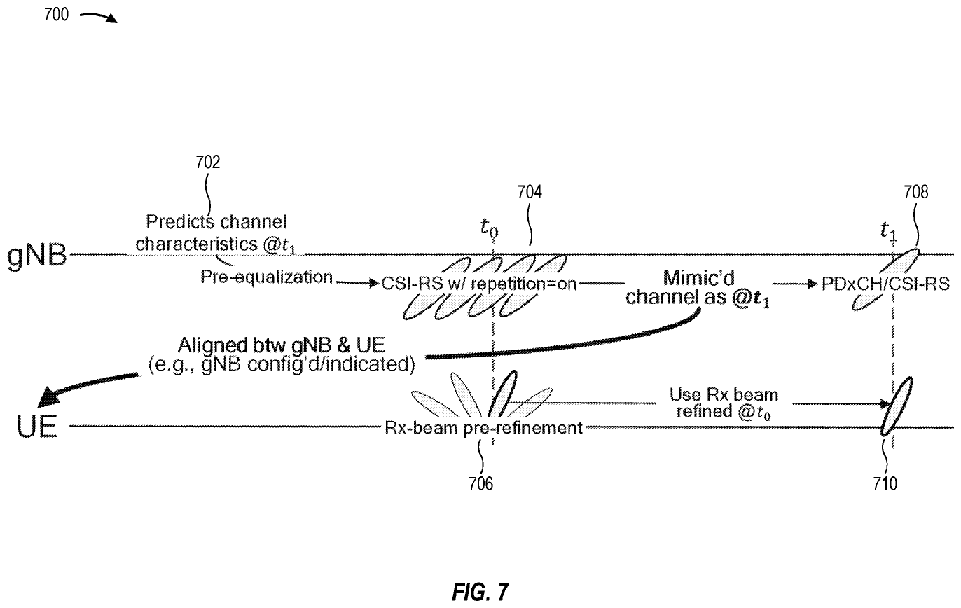

FIG. 7 illustrates an example of how a network entity (e.g., a gNB) may apply pre-equalization to CSI-RS repetitions transmitted, at 704, at a first time occasion t₀. The pre-equalization may be based on channel characteristics for a second time occasion t₁, predicted at 702.

The UE performs Rx beam refinement, at 706, based on the CSI-RS transmitted at t₀. At 710, the UE may then use the refined Rx beam, at the second time occasion t₁, to process a downlink transmission transmitted by the gNB, at 708.

In some cases, the downlink transmission may be a PDSCH scheduled for transmission according to a semi-persistent scheduling (SPS) configuration or a PDCCH. In some cases, the downlink transmission may be a second CSI-RS transmitted at the second time occasion t₁.

In certain aspects, the PDxCH or second CSI-RS may be at least spatially (TypeD) quasi co-located (QCL'ed) with the one or more CSI-RS scheduled at the first time occasion. According to certain aspects, one or more associations between the first and the second time occasions may be further gNB configured or indicated.

In certain aspects, the one or more CSI-RS resources scheduled at the first TD occasion, may be a CSI-RS resource set w/ repetition=on. In certain aspects, the one or more CSI-RS resources may be further based on one or more CSI-RS resource sets. In certain aspects, the CSI-RS resources scheduled at the first TD occasion may within the same BWP as the PDxCH/CSI-RS scheduled at the second TD occasion.

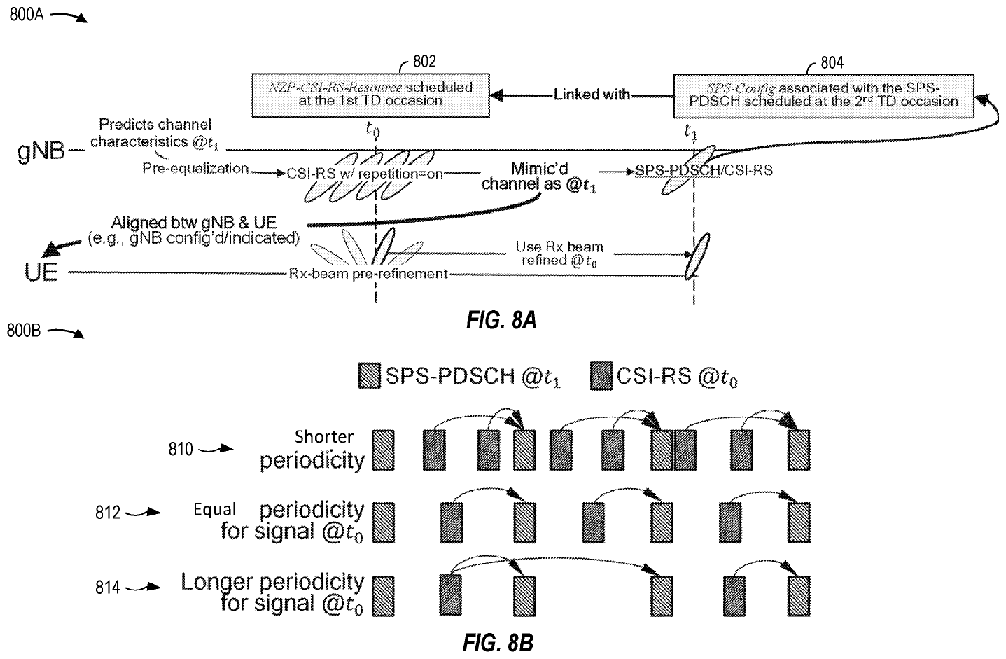

As illustrated, at 804 in FIG. 8A, the downlink transmission at the second time occasion t₁ may be an SPS-PDSCH. As shown, the SPS-PDSCH may be scheduled according to an SPS configuration linked with a non zero power (NZP) CSI RS resource scheduled at the first time occasion t₀, as shown at 802.

In some cases, the PDSCH scheduled at the second TD occasion is SPS configured. In such cases, the SPS configuration of the PDSCH may include the CSI-RS resource IDs (or CSI-RS resource set IDs) scheduled at the first TD occasion. In such cases, the first TD occasion may be defined as a TD occasion after a third TD occasion where the SPS-PDSCH is also scheduled, where the third TD occasion is the SPS-PDSCH transmission occasion before and closest to the second TD occasion.

FIG. 8B illustrates how the CSI-RS transmitted at to and the SPS-PDSCH transmitted at t₁ may have equal or different periodicities. CSI-RS with a shorter periodicity (more frequent) than the SPS-PDSCH is shown at 810, CSI-RS with an equal periodicity as the SPS-PDSCH is shown at 812, while CSI-RS with a longer periodicity (less frequent) than the SPS-PDSCH is shown at 814.

In some cases, if the periodicities of the persistent or semi-persistent CSI-RS resources scheduled at the first TD occasion are shorter than the periodicity of the SPS-PDSCH, there could be multiple first TD occasions scheduled before the second TD occasions. In such cases, the UE may assume that channel characteristics received at such multiple different first TD occasions are all identical as the channel characteristics to be received at the second TD occasion.

In some cases, if the periodicities of the persistent or semi-persistent CSI-RS resources scheduled at the first TD occasion are longer than the periodicity of the SPS-PDSCH, there could be multiple second TD occasions scheduled after a single first TD occasion. In such cases, the UE may assume that channel characteristics associated with such second TD occasions are similar (e.g., virtually identical), and that the channel characteristics associated with such second TD occasions may be mimicked by the channel characteristics received at the single first TD occasion.

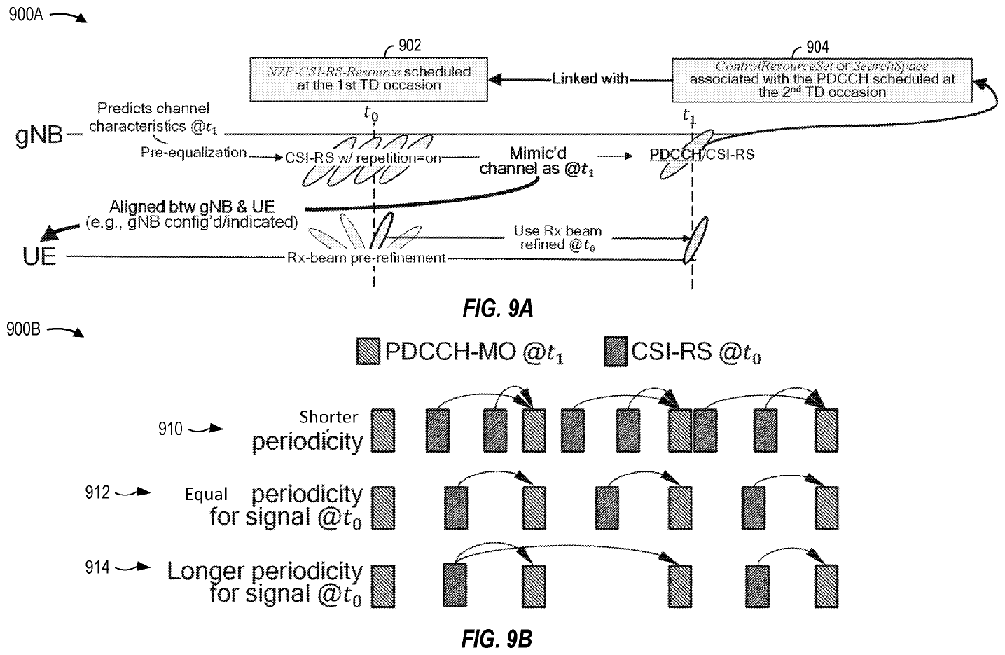

As illustrated, at 904 in FIG. 9A, the downlink transmission at the second time occasion t₁ may be a PDCCH. A control resource set (COREST) or search space (SS) associated with the PDCCH may be linked with a non zero power (NZP) CSI RS resource scheduled at the first time occasion t₀, as shown at 902.

In some cases, if PDCCH is scheduled at the second TD occasion, a radio resource control (RRC) configured ControlResourceSet or the SearchSpace associated with the PDCCH may include the CSI-RS resource IDs (or CSI-RS resource set IDs) scheduled at the second TD occasion. In such cases, the first TD occasion may be defined as a TD occasion after a third TD occasion where the PDCCH should also be monitored, wherein the third TD occasion is the PDCCH monitoring occasion (MO) before and closest to the second TD occasion.

FIG. 9B illustrates how the CSI-RS transmitted at t₀ and the PDCCH transmitted at t₁ may have equal or different periodicities. CSI-RS with a shorter periodicity (more frequent) than the PDCCH is shown at 910, CSI-RS with an equal periodicity as the PDCCH is shown at 912, while CSI-RS with a longer periodicity (less frequent) than the PDCCH is shown at 914.

In some cases, if the periodicities of P/SP-CSI-RS resources scheduled at the first TD occasion are shorter than the periodicity of the search space associated with the PDCCH, there may be multiple first TD occasions scheduled before the second TD occasions. In such cases, the UE may assume that channel characteristics received at such multiple different first TD occasions, are all identical as the channel characteristics to be received at the second TD occasion.

In some cases, if the periodicities of P/SP-CSI-RS resources scheduled at the first TD occasion are longer than the periodicity of the search space associated with the PDCCH, there may be multiple second TD occasions scheduled after a single first TD occasion. In such cases, the UE may assume that channel characteristics associated with such second TD occasions are similar (e.g., virtually identical), and that the channel characteristics associated with such second TD occasions may be mimicked by the channel characteristics received at the single first TD occasion.

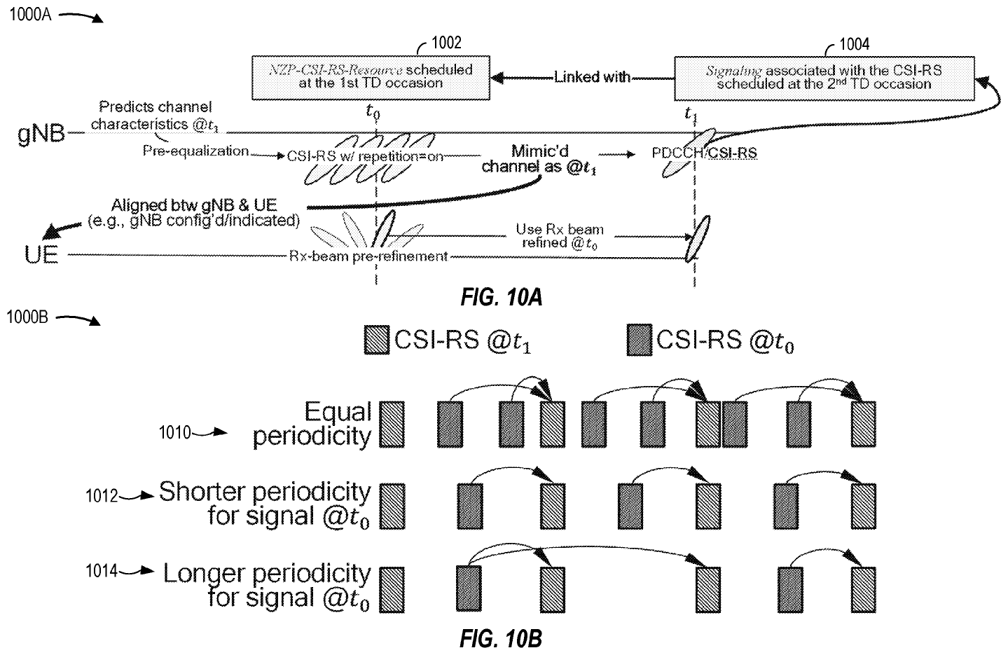

As illustrated, at 1004 in FIG. 10A, the downlink transmission at the second time occasion t₁ may be CSI-RS. Signaling associated with the CSI-RS may be linked with a non zero power (NZP) CSI RS resource scheduled at the first time occasion t₀, as shown at 1002.

In some cases, if CSI-RS resource(s) are scheduled at the second TD occasion, the RRC configured non zero power (NZP)-CSI-RS-Resource or NZP-CSI-RS-ResourceSet associated with the CSI-RS resource(s) scheduled at the second TD occasion, or a medium access control (MAC) control element (CE) activating the CSI-RS resources scheduled at the second TD occasion, or CSI-AssociatedReportConfigInfo for an aperiodic CSI report (wherein the CSI-RS resources associated with the aperiodic (AP) CSI report are the ones scheduled at the second TD occasion) may include the CSI-RS resource IDs (or CSI-RS resource set IDs) scheduled at the second TD occasion, as discussed above.

In such cases, the first TD occasion may be defined as a TD occasion after a third TD occasion where the CSI-RS resource(s) scheduled @t₀ are to be received, where the third TD occasion is the Tx occasion of the CSI-RS resources, which are the same as those scheduled at the second TD occasion, before and closest to the second TD occasion.

FIG. 10B illustrates how the CSI-RS transmitted at t₀ may have a shorter periodicity than the CSI-RS transmitted at t₁ (as shown at 1010), the CSI-RS transmitted at t₀ may have the same periodicity as the CSI-RS transmitted at t₁ (as shown at 1012), or the CSI-RS transmitted at t₀ may have a longer periodicity than the CSI-RS transmitted at t₁ (as shown at 1014).

In some cases, if the periodicities of P/SP-CSI-RS resources scheduled at the first TD occasion are shorter than the periodicity of P/SP CSI-RS resources scheduled at the second TD occasion, there may be multiple first TD occasions scheduled before the second TD occasions. In such cases, the UE may assume that channel characteristics received at such multiple different first TD occasions are all identical as the channel characteristics to be received at the second TD occasion.

In some cases, if the periodicities of P/SP-CSI-RS resources scheduled at the first TD occasion are longer than the periodicity of P/SP CSI-RS resources scheduled at the second TD occasion, there may be multiple second TD occasions scheduled after a single first TD occasion. In such cases, the UE may assume that channel characteristics associated with such second TD occasions are similar (e.g., virtually identical), and that the channel characteristics associated with such second TD occasions may be mimicked by the channel characteristics received at the single first TD occasion.

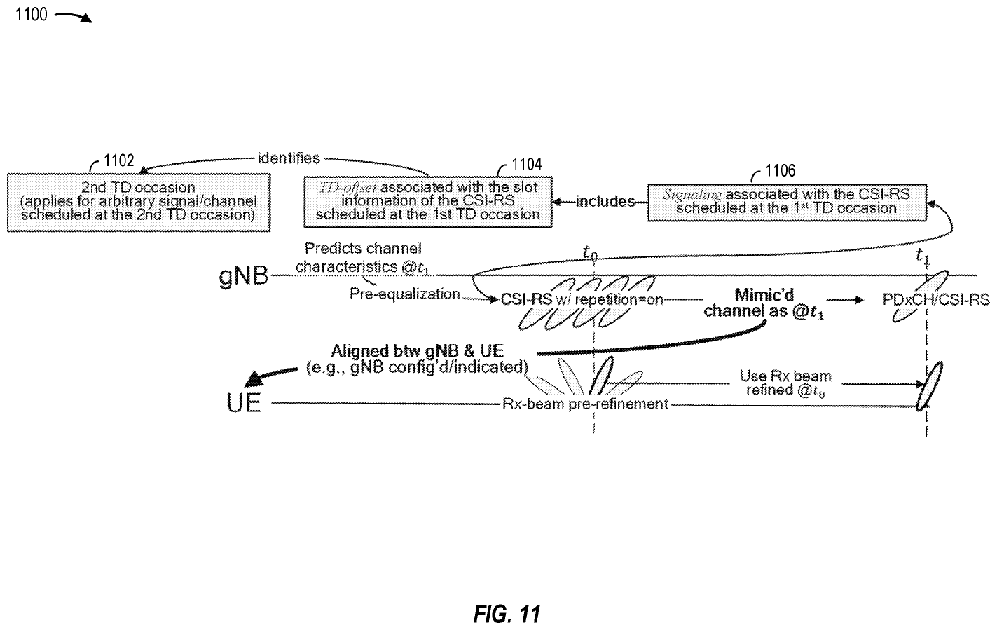

As illustrated, at 1106 in FIG. 11, signaling associated with the CSI-RS transmitted at t₀ may include an indication of a TD-offset, for example, associated with the slot information of the CSI-RS scheduled at t₀, as shown at 1104. The TD-offset may identify the second TD time occasion, as shown at 1102.

In this manner, signaling associated with the CSI-RS resource(s) scheduled at the first TD occasion may include information related to details of the second TD occasion. In such cases, the information may include a TD offset, which may be used to identify the second TD occasion (e.g., by applying the TD offset to details of the first TD occasion).

In some cases, for P/SP CSI-RS resources, RRC configurations of the CSI-RS resources scheduled at the first TD occasion, or CSI-RS resource set associated with the CSI resources, or CSI-RS resource setting associated with the CSI-RS resources, may include a TD offset associated with the slot information of the CSI-RS resources which identifies the second TD occasion.

In some cases, for SP CSI-RS resources, a MAC-CE activating a CSI-RS resource set associated with the CSI-RS resources scheduled at the first TD occasion may include a TD offset associated with the slot information of the CSI-RS resources activated by the MAC-CE, which identifies the second TD occasion.

In some cases, for aperiodic (AP) CSI-RS resources a CSI-AssociatedReportConfigInfo associated with an AP CSI report, further comprises a TD offset associated with the slot information of the CSI-RS resources associated with the AP CSI report, which identifies the second TD occasion.

The signaling design described herein may provide flexibility, in terms of what type of signal or channel is scheduled at the second TD occasion.

In some cases, a UE may separately report capability information indicating the total number of such special type of CSI-RS resources, which may be RRC configured or simultaneously activated.

In some cases, the capability to apply beam refinement at a first TD occasion to a later TD occasion, as described herein, may be reported as UE capabilities. For example, in some cases, a UE may report whether the UE is capable of applying an adjustment to one or more receive characteristics, determined based on measurement of the one or more CSI-RS output for transmission at the first time occasion, when processing the downlink channel or reference signal output for transmission at the second time occasion. For example, in some cases, the UE may report whether the UE is capable of supporting gNB configured/indicated TD pre-equalization for CSI-RSs. In some cases, utilization of such techniques may be further based on reporting such capabilities separately for PDSCH, PDCCH, and/or CSI-RS that are scheduled at the second TD occasion.

One reason for such capability reporting is because not all UEs may have the capability to support the feature or be willing to perform additional processing (and utilize resources) to apply beam refinement at a first TD occasion to a later TD occasion. For example, to apply beam refinement at a first TD occasion to a later TD occasion, a UE may need to create a dedicated memory/buffer to track the Rx beams refined based on a certain set of CSI-RSs in order to prepare them for receiving later PDxCH/CSI-RS, utilizing memory and increasing computational complexity.

### Example Operations of User Equipment

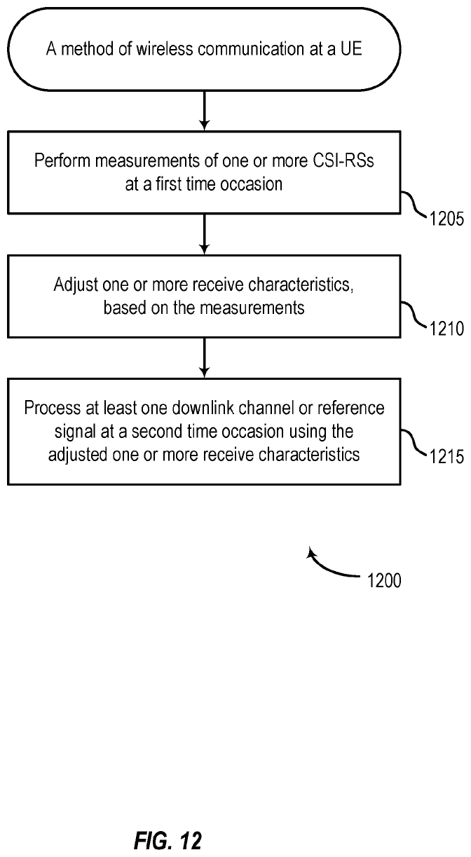

FIG. 12 shows an example of a method 1200 of wireless communication at a UE, such as a UE 104 of FIGS. 1 and 3.

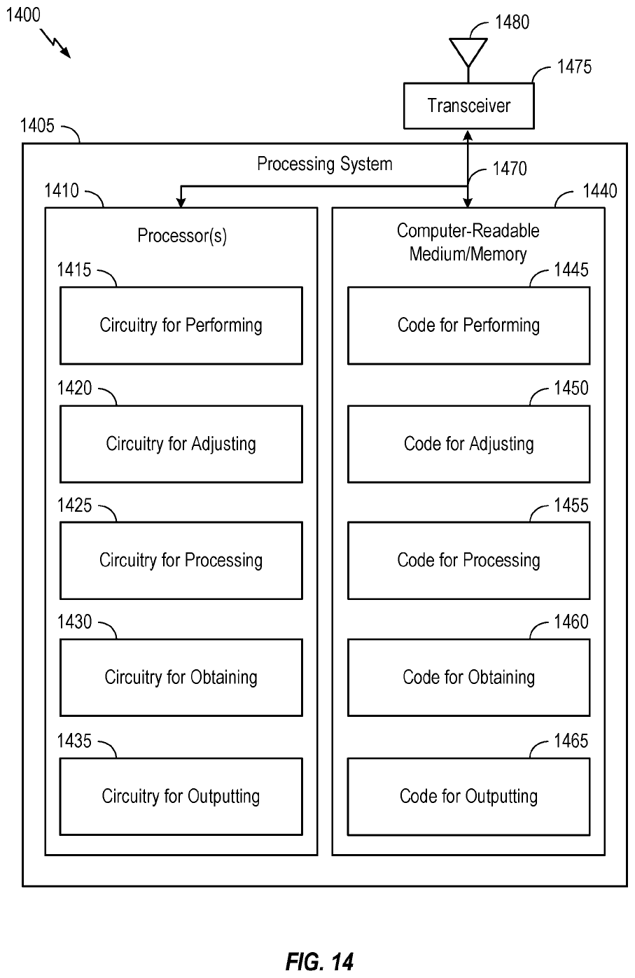

Method 1200 begins at step 1205 with performing measurements of one or more CSI-RSs at a first time occasion. In some cases, the operations of this step refer t₀, or may be performed by, circuitry for performing and/or code for performing as described with reference to FIG. 14.

Method 1200 then proceeds to step 1210 with adjusting one or more receive characteristics, based on the measurements. In some cases, the operations of this step refer to, or may be performed by, circuitry for adjusting and/or code for adjusting as described with reference to FIG. 14.

Method 1200 then proceeds to step 1215 with processing at least one downlink channel or reference signal at a second time occasion using the adjusted one or more receive characteristics. In some cases, the operations of this step refer t₀, or may be performed by, circuitry for processing and/or code for processing as described with reference to FIG. 14.

In some aspects, the method 1200 further includes obtaining, from a network entity, an indication that the network entity will output the one or more CSI-RSs at the first time occasion with pre-processing based on channel characteristics predicted for the second time occasion. In some cases, the operations of this step refer to, or may be performed by, circuitry for obtaining and/or code for obtaining as described with reference to FIG. 14.

In some aspects, the method 1200 further includes obtaining, from a network entity, an indication that the UE can apply beam refinement, determined based on measurements of the one or more CSI-RSs at the first time occasion, when processing the downlink channel or reference signal at the second time occasion. In some cases, the operations of this step refer to, or may be performed by, circuitry for obtaining and/or code for obtaining as described with reference to FIG. 14.

In some aspects, the one or more CSI-RSs and the downlink channel or reference signal are QCL'ed spatially.

In some aspects, at least two of the one or more CSI-RSs, the downlink channel and the reference signal are obtained within a same BWP.

In some aspects, the at least one downlink channel or reference signal comprises a PDSCH scheduled according to a SPS configuration; and the SPS configuration indicates CSI-RS resource IDs or CSI-RS resource set IDs for the one or more CSI-RSs.

In some aspects, the SPS configuration schedules the PDSCH according to a first periodicity; and the one or more CSI-RSs are scheduled with a second periodicity that is equal to or different than the first periodicity.

In some aspects, the at least one downlink channel or reference signal comprises a PDCCH; and a configuration of a CORESET or a search space associated with the PDCCH indicates CSI-RS resource IDs or CSI-RS resource set IDs for the one or more CSI-RSs.

In some aspects, the configuration of the CORESET or the search space schedules PDCCH MOs with a first periodicity; and the one or more CSI-RSs are scheduled with a second periodicity that is equal to or different than the first periodicity.

In some aspects, the at least one downlink channel or reference signal comprises a second CSI-RS; and CSI-RS resource IDs or CSI-RS resource set IDs for the one or more CSI-RSs are indicated via at least one of: a CSI-RS resource or CSI-RS resource set configuration associated with the second CSI-RS, a MAC-CE activating the second CSI-RS, or a configuration for an aperiodic CSI report.

In some aspects, the second CSI-RS is output for transmission at the second time occasion on a periodic or SPS CSI-RS resource scheduled with a first periodicity; and the one or more CSI-RSs are scheduled with a second periodicity that is equal to or different than the first periodicity.

In some aspects, the method 1200 further includes obtaining a time domain offset that indicates the second time occasion relative to the first time occasion. In some cases, the operations of this step refer to, or may be performed by, circuitry for obtaining and/or code for obtaining as described with reference to FIG. 14.

In some aspects, the time domain offset is obtained as part of at least one of: a configuration of CSI-RS resources or CSI-RS resource sets associated with the one or more CSI-RSs; a MAC-CE activating a CSI-RS resource associated with the one or more CSI-RSs; or an aperiodic CSI report configuration.

In some aspects, the method 1200 further includes outputting capability information indicating a total number of CSI-RS resources that can be RRC configured or simultaneously activated for the UE. In some cases, the operations of this step refer t₀, or may be performed by, circuitry for outputting and/or code for outputting as described with reference to FIG. 14.

In some aspects, the method 1200 further includes outputting capability information indicating that the UE is capable of applying an adjustment to one or more receive characteristics, determined based on measurement of the one or more CSI-RSs at the first time occasion, when processing the downlink channel or reference signal at the second time occasion. In some cases, the operations of this step refer t₀, or may be performed by, circuitry for outputting and/or code for outputting as described with reference to FIG. 14.

In some aspects, the adjustment to one or more receive characteristics comprises refinement of a receive beam.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of a Network Entity

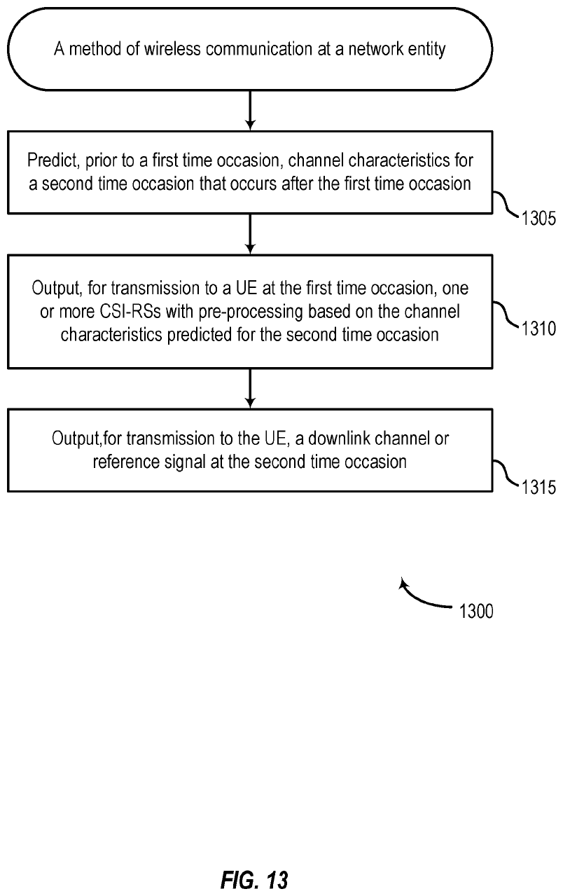

FIG. 13 shows an example of a method 1300 of wireless communication at a network entity, such as a BS 102 of FIGS. 1 and 3, or a disaggregated base station as discussed with respect to FIG. 2.

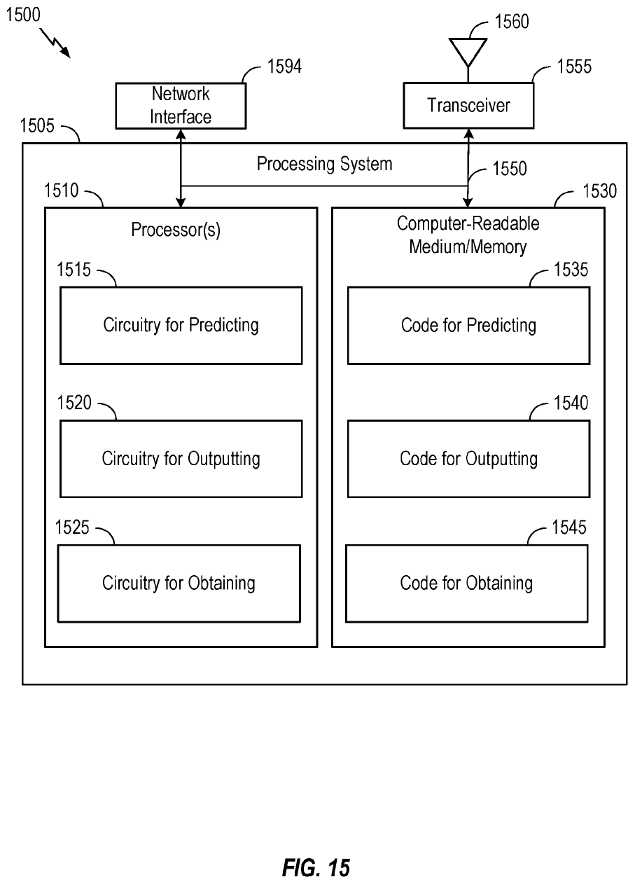

Method 1300 begins at step 1305 with predicting, prior to a first time occasion, channel characteristics for a second time occasion that occurs after the first time occasion. In some cases, the operations of this step refer t₀, or may be performed by, circuitry for predicting and/or code for predicting as described with reference to FIG. 15.

Method 1300 then proceeds to step 1310 with outputting, for transmission to a UE at the first time occasion, one or more CSI-RSs with pre-processing based on the channel characteristics predicted for the second time occasion. In some cases, the operations of this step refer to, or may be performed by, circuitry for outputting and/or code for outputting as described with reference to FIG. 15.

Method 1300 then proceeds to step 1315 with outputting, for transmission to the UE, a downlink channel or reference signal at the second time occasion. In some cases, the operations of this step refer to, or may be performed by, circuitry for outputting and/or code for outputting as described with reference to FIG. 15.

In some aspects, the method 1300 further includes outputting, for transmission to the UE, an indication that the network entity will output the one or more CSI-RSs at the first time occasion with pre-processing based on the channel characteristics predicted for the second time occasion. In some cases, the operations of this step refer to, or may be performed by, circuitry for outputting and/or code for outputting as described with reference to FIG. 15.

In some aspects, the method 1300 further includes outputting, for transmission to the UE, an indication that the UE can apply beam refinement when processing the downlink channel or reference signal. In some cases, the operations of this step refer to, or may be performed by, circuitry for outputting and/or code for outputting as described with reference to FIG. 15.

In some aspects, at least two of the one or more CSI-RSs, the downlink channel and the reference signal are QCL'ed spatially.

In some aspects, at least two of the one or more CSI-RSs, the downlink channel, and the reference signal are output for transmission within a same BWP.

In some aspects, the downlink channel or reference signal comprises a PDSCH scheduled for transmission according to a SPS configuration; and the SPS configuration indicates CSI-RS resource IDs or CSI-RS resource set IDs for the one or more CSI-RSs output for transmission at the first time occasion.

In some aspects, the SPS configuration schedules the PDSCH to be output for transmission according to a first periodicity; and the one or more CSI-RSs are scheduled to be output for transmission with a second periodicity that is equal to or different than the first periodicity.

In some aspects, the downlink channel or reference signal comprises a PDCCH; and a configuration of a CORESET or a search space associated with the PDCCH indicates CSI-RS resource IDs or CSI-RS resource set IDs for the one or more CSI-RSs output for transmission at the first time occasion.

In some aspects, the configuration of the CORESET or the search space schedules PDCCH MOs with a first periodicity; and the one or more CSI-RSs are scheduled to be output for transmission with a second periodicity that is equal to or different than the first periodicity.

In some aspects, the downlink channel or reference signal comprises a CSI-RS output for transmission at the second time occasion; and CSI-RS resource IDs or CSI-RS resource set IDs for the one or more CSI-RSs output for transmission at the first time occasion are indicated via at least one of: a CSI-RS resource or CSI-RS resource set configuration associated with the CSI-RS output for transmission at the second time occasion, a MAC-CE activating the CSI-RS output for transmission at the second time occasion, or a configuration for an aperiodic CSI report.

In some aspects, the CSI-RS is output for transmission at the second time occasion on a periodic or SPS CSI-RS resource scheduled with a first periodicity; and the one or more CSI-RSs are output for transmission at the first time occasion on CSI-RS resources scheduled to be output for transmission with a second periodicity that is equal to or different than the first periodicity.

In some aspects, the method 1300 further includes obtaining a time domain offset that indicates the second time occasion relative to the first time occasion. In some cases, the operations of this step refer t₀, or may be performed by, circuitry for obtaining and/or code for obtaining as described with reference to FIG. 15.

In some aspects, the time domain offset is obtained as part of at least one of: a configuration of CSI-RS resources or CSI-RS resource sets associated with the one or more CSI-RSs; a MAC-CE activating a CSI-RS resource associated with the one or more CSI-RSs; or an aperiodic CSI report configuration.

In some aspects, the method 1300 further includes obtaining capability information indicating a total number of CSI-RS resources that can be RRC configured or simultaneously activated for the UE. In some cases, the operations of this step refer t₀, or may be performed by, circuitry for obtaining and/or code for obtaining as described with reference to FIG. 15.

In some aspects, the method 1300 further includes obtaining capability information indicating that the UE is capable of applying an adjustment to one or more receive characteristics when processing the downlink channel or the reference signal, wherein the one or more receive characteristics are associated with the one or more CSI-RSs output for transmission at the first time occasion. In some cases, the operations of this step refer to, or may be performed by, circuitry for obtaining and/or code for obtaining as described with reference to FIG. 15.

In some aspects, the adjustment to one or more receive characteristics comprises a refinement of a receive beam.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to the transceiver 1475 (e.g., a transmitter and/or a receiver). The transceiver 1475 is configured to transmit and receive signals for the communications device 1400 via the antenna 1480, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1440 via a bus 1470. In certain aspects, the computer-readable medium/memory 1440 is configured to store instructions (e.g., computer-executable code) that when executed by the one or more processors 1410, cause the one or more processors 1410 to perform the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1440 stores code (e.g., executable instructions), such as code for performing 1445, code for adjusting 1450, code for processing 1455, code for obtaining 1460, and code for outputting 1465. Processing of the code for performing 1445, code for adjusting 1450, code for processing 1455, code for obtaining 1460, and code for outputting 1465 may cause the communications device 1400 to perform the method 1200 described with respect to FIG. 12, or any aspect related to it.

The one or more processors 1410 include circuitry configured to implement (e.g., execute) the code stored in the computer-readable medium/memory 1440, including circuitry such as circuitry for performing 1415, circuitry for adjusting 1420, circuitry for processing 1425, circuitry for obtaining 1430, and circuitry for outputting 1435. Processing with circuitry for performing 1415, circuitry for adjusting 1420, circuitry for processing 1425, circuitry for obtaining 1430, and circuitry for outputting 1435 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1475 and the antenna 1480 of the communications device 1400 in FIG. 14. Means for receiving or obtaining may include transceivers 354 and/or antenna(s) 352 of the UE 104 illustrated in FIG. 3 and/or the transceiver 1475 and the antenna 1480 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1555 (e.g., a transmitter and/or a receiver) and/or a network interface 1565. The transceiver 1555 is configured to transmit and receive signals for the communications device 1500 via the antenna 1560, such as the various signals as described herein. The network interface 1565 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1530 stores code (e.g., executable instructions), such as code for predicting 1535, code for outputting 1540, and code for obtaining 1545. Processing of the code for predicting 1535, code for outputting 1540, and code for obtaining 1545 may cause the communications device 1500 to perform the method 1300 described with respect to FIG. 13, or any aspect related to it.

The one or more processors 1510 include circuitry configured to implement (e.g., execute) the code stored in the computer-readable medium/memory 1530, including circuitry such as circuitry for predicting 1515, circuitry for outputting 1520, and circuitry for obtaining 1525. Processing with circuitry for predicting 1515, circuitry for outputting 1520, and circuitry for obtaining 1525 may cause the communications device 1500 to perform the method 1300 described with respect to FIG. 13, or any aspect related to it.

Various components of the communications device 1500 may provide means for performing the method 1300 described with respect to FIG. 13, or any aspect related to it. Means for transmitting, sending or outputting for transmission may include transceivers 332 and/or antenna(s) 334 of the BS 102 illustrated in FIG. 3 and/or the transceiver 1555 and the antenna 1560 of the communications device 1500 in FIG. 15. Means for receiving or obtaining may include transceivers 332 and/or antenna(s) 334 of the BS 102 illustrated in FIG. 3 and/or the transceiver 1555 and the antenna 1560 of the communications device 1500 in FIG. 15. In some aspects, means for predicting, means for performing, means for adjusting, and/or means for processing may include one or more of the processors illustrated in FIG. 2.

### Example Clauses

Implementation examples are described in the following numbered clauses:

Clause 1: A method of wireless communication at a network entity, comprising: predicting, prior to a first time occasion, channel characteristics for a second time occasion that occurs after the first time occasion; outputting, for transmission to a UE at the first time occasion, one or more CSI-RSs with pre-processing based on the channel characteristics predicted for the second time occasion; and outputting, for transmission to the UE, a downlink channel or reference signal at the second time occasion.

Clause 2: The method of Clause 1, further comprising: outputting, for transmission to the UE, an indication that the network entity will output the one or more CSI-RSs at the first time occasion with pre-processing based on the channel characteristics predicted for the second time occasion.

Clause 3: The method of any one of Clauses 1 and 2, further comprising: outputting, for transmission to the UE, an indication that the UE can apply beam refinement when processing the downlink channel or reference signal.

Clause 4: The method of any one of Clauses 1-3, wherein at least two of the one or more CSI-RSs, the downlink channel and the reference signal are QCL'ed spatially.

Clause 5: The method of any one of Clauses 1-4, wherein at least two of the one or more CSI-RSs, the downlink channel, and the reference signal are output for transmission within a same BWP.

Clause 6: The method of any one of Clauses 1-5, wherein: the downlink channel or reference signal comprises a PDSCH scheduled for transmission according to a SPS configuration; and the SPS configuration indicates CSI-RS resource IDs or CSI-RS resource set IDs for the one or more CSI-RSs output for transmission at the first time occasion.

Clause 7: The method of Clause 6, wherein: the SPS configuration schedules the PDSCH to be output for transmission according to a first periodicity; and the one or more CSI-RSs are scheduled to be output for transmission with a second periodicity that is equal to or different than the first periodicity.

Clause 8: The method of any one of Clauses 1-7, wherein: the downlink channel or reference signal comprises a PDCCH; and a configuration of a CORESET or a search space associated with the PDCCH indicates CSI-RS resource IDs or CSI-RS resource set IDs for the one or more CSI-RSs output for transmission at the first time occasion.

Clause 9: The method of Clause 8, wherein: the configuration of the CORESET or the search space schedules PDCCH MOs with a first periodicity; and the one or more CSI-RSs are scheduled to be output for transmission with a second periodicity that is equal to or different than the first periodicity.

Clause 10: The method of any one of Clauses 1-9, wherein: the downlink channel or reference signal comprises a CSI-RS output for transmission at the second time occasion; and CSI-RS resource IDs or CSI-RS resource set IDs for the one or more CSI-RSs output for transmission at the first time occasion are indicated via at least one of: a CSI-RS resource or CSI-RS resource set configuration associated with the CSI-RS output for transmission at the second time occasion, a MAC-CE activating the CSI-RS output for transmission at the second time occasion, or a configuration for an aperiodic CSI report.

Clause 11: The method of Clause 10, wherein: the CSI-RS is output for transmission at the second time occasion on a periodic or SPS CSI-RS resource scheduled with a first periodicity; and the one or more CSI-RSs are output for transmission at the first time occasion on CSI-RS resources scheduled to be output for transmission with a second periodicity that is equal to or different than the first periodicity.

Clause 12: The method of any one of Clauses 1-11, further comprising: obtaining a time domain offset that indicates the second time occasion relative to the first time occasion.

Clause 13: The method of Clause 12, wherein the time domain offset is obtained as part of at least one of: a configuration of CSI-RS resources or CSI-RS resource sets associated with the one or more CSI-RSs; a MAC-CE activating a CSI-RS resource associated with the one or more CSI-RSs; or an aperiodic CSI report configuration.

Clause 14: The method of any one of Clauses 1-13, further comprising: obtaining capability information indicating a total number of CSI-RS resources that can be RRC configured or simultaneously activated for the UE.

Clause 15: The method of any one of Clauses 1-14, further comprising: obtaining capability information indicating that the UE is capable of applying an adjustment to one or more receive characteristics when processing the downlink channel or the reference signal, wherein the one or more receive characteristics are associated with the one or more CSI-RSs output for transmission at the first time occasion.

Clause 16: The method of Clause 15, wherein the adjustment to one or more receive characteristics comprises a refinement of a receive beam.

Clause 17: A method of wireless communication at a UE, comprising: performing measurements of one or more CSI-RSs at a first time occasion; adjusting one or more receive characteristics, based on the measurements; and processing at least one downlink channel or reference signal at a second time occasion using the adjusted one or more receive characteristics.

Clause 18: The method of Clause 17, further comprising: obtaining, from a network entity, an indication that the network entity will output the one or more CSI-RSs at the first time occasion with pre-processing based on channel characteristics predicted for the second time occasion.

Clause 19: The method of any one of Clauses 17 and 18, further comprising: obtaining, from a network entity, an indication that the UE can apply beam refinement, determined based on measurements of the one or more CSI-RSs at the first time occasion, when processing the downlink channel or reference signal at the second time occasion.

Clause 20: The method of any one of Clauses 17-19, wherein the one or more CSI-RSs and the downlink channel or reference signal are QCL'ed spatially.

Clause 21: The method of any one of Clauses 17-20, wherein at least two of the one or more CSI-RSs, the downlink channel and the reference signal are obtained within a same BWP.

Clause 22: The method of any one of Clauses 17-21, wherein: the at least one downlink channel or reference signal comprises a PDSCH scheduled according to a SPS configuration; and the SPS configuration indicates CSI-RS resource IDs or CSI-RS resource set IDs for the one or more CSI-RSs.

Clause 23: The method of Clause 22, wherein: the SPS configuration schedules the PDSCH according to a first periodicity; and the one or more CSI-RSs are scheduled with a second periodicity that is equal to or different than the first periodicity.

Clause 24: The method of any one of Clauses 17-23, wherein: the at least one downlink channel or reference signal comprises a PDCCH; and a configuration of a CORESET or a search space associated with the PDCCH indicates CSI-RS resource IDs or CSI-RS resource set IDs for the one or more CSI-RSs.

Clause 25: The method of Clause 24, wherein: the configuration of the CORESET or the search space schedules PDCCH MOs with a first periodicity; and the one or more CSI-RSs are scheduled with a second periodicity that is equal to or different than the first periodicity.

Clause 26: The method of any one of Clauses 17-25, wherein: the at least one downlink channel or reference signal comprises a second CSI-RS; and CSI-RS resource IDs or CSI-RS resource set IDs for the one or more CSI-RSs are indicated via at least one of: a CSI-RS resource or CSI-RS resource set configuration associated with the second CSI-RS, a MAC-CE activating the second CSI-RS, or a configuration for an aperiodic CSI report.

Clause 27: The method of Clause 26, wherein: the second CSI-RS is output for transmission at the second time occasion on a periodic or SPS CSI-RS resource scheduled with a first periodicity; and the one or more CSI-RSs are scheduled with a second periodicity that is equal to or different than the first periodicity.

Clause 28: The method of any one of Clauses 17-27, further comprising: obtaining a time domain offset that indicates the second time occasion relative to the first time occasion.

Clause 29: The method of Clause 28, wherein the time domain offset is obtained as part of at least one of: a configuration of CSI-RS resources or CSI-RS resource sets associated with the one or more CSI-RSs; a MAC-CE activating a CSI-RS resource associated with the one or more CSI-RSs; or an aperiodic CSI report configuration.

Clause 30: The method of any one of Clauses 17-29, further comprising: outputting capability information indicating a total number of CSI-RS resources that can be RRC configured or simultaneously activated for the UE.

Clause 31: The method of any one of Clauses 17-30, further comprising: outputting capability information indicating that the UE is capable of applying an adjustment to one or more receive characteristics, determined based on measurement of the one or more CSI-RSs at the first time occasion, when processing the downlink channel or reference signal at the second time occasion.

Clause 32: The method of Clause 31, wherein the adjustment to one or more receive characteristics comprises refinement of a receive beam.

Clause 33: An apparatus, comprising: a memory comprising executable instructions; and a processor configured to execute the executable instructions and cause the apparatus to perform a method in accordance with any one of Clauses 1-32.

Clause 34: An apparatus, comprising means for performing a method in accordance with any one of Clauses 1-32.

Clause 35: A non-transitory computer-readable medium comprising executable instructions that, when executed by a processor of an apparatus, cause the apparatus to perform a method in accordance with any one of Clauses 1-32.

Clause 36: A computer program product embodied on a computer-readable storage medium comprising code for performing a method in accordance with any one of Clauses 1-32.

Clause 37: A network entity, comprising: at least one transceiver; a memory comprising instructions; and one or more processors configured to execute the instructions and cause the network entity to perform a method in accordance with any one of Clauses 1-16, wherein the at least one transceiver is configured to transmit the one or more CSI-RSs and the downlink channel or reference signal.

Clause 38: A user equipment (UE), comprising: at least one transceiver; a memory comprising instructions; and one or more processors configured to execute the instructions and cause the UE to perform a method in accordance with any one of Clauses 17-32, wherein the at least one transceiver is configured to receive the one or more CSI-RSs and the at least one downlink channel or reference signal.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, comprising: a memory comprising processor-executable instructions; and one or more processors configured to execute the processor-executable instructions to cause the apparatus to:
predict, prior to a first time occasion, channel characteristics for a second time occasion that occurs after the first time occasion;
output, for transmission to a user equipment (UE) at the first time occasion, one or more channel state information reference signals (CSI-RSs) with pre-processing based on the channel characteristics predicted for the second time occasion; and
output, for transmission to the UE, a downlink channel or reference signal at the second time occasion.

2. The apparatus of claim 1, wherein the one or more processors are further configured to execute the processor-executable instructions to cause the apparatus to at least one of:
output, for transmission to the UE, an indication that the apparatus will output the one or more CSI-RSs at the first time occasion with pre-processing based on the channel characteristics predicted for the second time occasion; or
output, for transmission to the UE, an indication that the UE can apply beam refinement when processing the downlink channel or reference signal.

3. (canceled)

4. The apparatus of claim 1, wherein at least one of:
at least two of the one or more CSI-RSs, the downlink channel and the reference signal are quasi co-located (QCL'ed) spatially; or
at least two of the one or more CSI-RSs, the downlink channel, and the reference signal are output for transmission within a same bandwidth part (BWP).

5. (canceled)

6. The apparatus of claim 1, wherein:
the downlink channel or reference signal comprises a physical downlink shared channel (PDSCH) scheduled for transmission according to a semi-persistent scheduling (SPS) configuration;
the SPS configuration indicates CSI-RS resource IDs or CSI-RS resource set IDs for the one or more CSI-RSs output for transmission at the first time occasion;
the SPS configuration schedules the PDSCH to be output for transmission according to a first periodicity; and
the one or more CSI-RSs are scheduled to be output for transmission with a second periodicity that is equal to or different than the first periodicity.

7. The apparatus of claim 1, wherein:
the downlink channel or reference signal comprises a physical downlink control channel (PDCCH);
a configuration of a control resource set (CORESET) or a search space associated with the PDCCH indicates CSI-RS resource IDs or CSI-RS resource set IDs for the one or more CSI-RSs output for transmission at the first time occasion;
the configuration of the CORESET or the search space schedules PDCCH monitoring occasions (MOs) with a first periodicity; and
the one or more CSI-RSs are scheduled to be output for transmission with a second periodicity that is equal to or different than the first periodicity.

8. The apparatus of claim 1, wherein:
the downlink channel or reference signal comprises a CSI-RS output for transmission at the second time occasion; and
CSI-RS resource IDs or CSI-RS resource set IDs for the one or more CSI-RSs output for transmission at the first time occasion are indicated via at least one of:
a CSI-RS resource or CSI-RS resource set configuration associated with the CSI-RS output for transmission at the second time occasion,
a medium access control (MAC) control element (CE) activating the CSI-RS output for transmission at the second time occasion, or
a configuration for an aperiodic CSI report.

9. The apparatus of claim 8, wherein:
the CSI-RS is output for transmission at the second time occasion on a periodic or semi-persistently scheduled (SPS) CSI-RS resource scheduled with a first periodicity; and
the one or more CSI-RSs are output for transmission at the first time occasion on CSI-RS resources scheduled to be output for transmission with a second periodicity that is equal to or different than the first periodicity.

10. The apparatus of claim 1, wherein the one or more processors are further configured to execute the processor-executable instructions to cause the apparatus to obtain a time domain offset that indicates the second time occasion relative to the first time occasion, wherein the time domain offset is obtained as part of at least one of:
a configuration of CSI-RS resources or CSI-RS resource sets associated with the one or more CSI-RSs;
a medium access control (MAC) control element (CE) activating a CSI-RS resource associated with the one or more CSI-RSs; or
an aperiodic CSI report configuration.

11. The apparatus of claim 1, wherein the one or more processors are further configured to execute the processor-executable instructions to cause the apparatus to obtain capability information indicating a total number of CSI-RS resources that can be RRC configured or simultaneously activated for the UE.

12. The apparatus of claim 1, wherein the one or more processors are further configured to execute the processor-executable instructions to cause the apparatus to obtain capability information indicating that the UE is capable of applying an adjustment to one or more receive characteristics when processing the downlink channel or the reference signal, wherein:
the one or more receive characteristics are associated with the one or more CSI-RSs output for transmission at the first time occasion, and
the adjustment to one or more receive characteristics comprises a refinement of a receive beam.

13. (canceled)

14. An apparatus for wireless communication, comprising: a memory comprising processor-executable instructions; and one or more processors configured to execute the processor-executable instructions to cause the apparatus to:
perform measurements of one or more channel state information (CSI) reference signals (RSs) at a first time occasion;
adjust one or more receive characteristics, based on the measurements; and
process at least one downlink channel or reference signal at a second time occasion using the adjusted one or more receive characteristics.

15. The apparatus of claim 14, wherein the one or more processors are further configured to execute the processor-executable instructions to cause the apparatus to at least one of:
obtain, from a network entity, an indication that the network entity will output the one or more CSI-RSs at the first time occasion with pre-processing based on channel characteristics predicted for the second time occasion; or
obtain, from a network entity, an indication that the apparatus can apply beam refinement, determined based on measurements of the one or more CSI-RSs at the first time occasion, when processing the downlink channel or reference signal at the second time occasion.

16. (canceled)

17. The apparatus of claim 14, wherein at least one of:
the one or more CSI-RSs and the downlink channel or reference signal are quasi co-located (QCL'ed) spatially; or
at least two of the one or more CSI-RSs, the downlink channel and the reference signal are obtained within a same bandwidth part (BWP).

18. (canceled)

19. The apparatus of claim 15, wherein:
the at least one downlink channel or reference signal comprises a physical downlink shared channel (PDSCH) scheduled according to a semi-persistent scheduling (SPS) configuration, and the SPS configuration indicates CSI-RS resource IDs or CSI-RS resource set IDs for the one or more CSI-RSs; or
the SPS configuration schedules the PDSCH according to a first periodicity, and the one or more CSI-RSs are scheduled with a second periodicity that is equal to or different than the first periodicity.

20. (canceled)

21. The apparatus of claim 15, wherein:
the at least one downlink channel or reference signal comprises a physical downlink control channel (PDCCH), and a configuration of a control resource set (CORESET) or a search space associated with the PDCCH indicates CSI-RS resource IDs or CSI-RS resource set IDs for the one or more CSI-RSs; or
the configuration of the CORESET or the search space schedules PDCCH monitoring occasions (MOs) with a first periodicity, and the one or more CSI-RSs are scheduled with a second periodicity that is equal to or different than the first periodicity.

22. (canceled)

23. The apparatus of claim 15, wherein:
the at least one downlink channel or reference signal comprises a second CSI-RS; and
CSI-RS resource IDs or CSI-RS resource set IDs for the one or more CSI-RSs are indicated via at least one of: a CSI-RS resource or CSI-RS resource set configuration associated with the second CSI-RS, a medium access control (MAC) control element (CE) activating the second CSI-RS, or a configuration for an aperiodic CSI report.

24. The apparatus of claim 23, wherein:
the second CSI-RS is output for transmission at the second time occasion on a periodic or semi-persistently scheduled (SPS) CSI-RS resource scheduled with a first periodicity; and
the one or more CSI-RSs are scheduled with a second periodicity that is equal to or different than the first periodicity.

25. The apparatus of claim 15, wherein the one or more processors are further configured to execute the processor-executable instructions to cause the apparatus to obtain a time domain offset that indicates the second time occasion relative to the first time occasion.

26. The apparatus of claim 25, wherein the time domain offset is obtained as part of at least one of:
a configuration of CSI-RS resources or CSI-RS resource sets associated with the one or more CSI-RSs;
a medium access control (MAC) control element (CE) activating a CSI-RS resource associated with the one or more CSI-RSs; or
an aperiodic CSI report configuration.

27. The apparatus of claim 15, wherein at least one of:
the one or more processors are further configured to execute the processor-executable instructions to cause the apparatus to output capability information indicating a total number of CSI-RS resources that can be RRC configured or simultaneously activated for the apparatus;
the one or more processors are further configured to execute the processor-executable instructions and cause the apparatus to output capability information indicating that the apparatus is capable of applying an adjustment to one or more receive characteristics, determined based on measurement of the one or more CSI-RSs at the first time occasion, when processing the downlink channel or reference signal at the second time occasion; or
the adjustment to one or more receive characteristics comprises refinement of a receive beam.

28-30. (canceled)
